(19) United States
(12) Patent Application Publication
(10) Pub. No.: US 2025/0332593 A1
(43) Pub. Date: Oct. 30, 2025

(54) DNA ORIGAMI NANOARRAYS

(71) Applicant: Arizona Board of Regents on behalf of Arizona State University, Scottsdale, AZ (US)

(72) Inventors: Rizal Hariadi, Phoenix, AZ (US); Prathamesh Chopade, Tempe, AZ (US)

(21) Appl. No.: 19/188,613

(22) Filed: Apr. 24, 2025

Related U.S. Application Data
(60) Provisional application No. 63/638,158, filed on Apr. 24, 2024.

(51) Int. Cl. B01L 3/00

(52) U.S. Cl. CPC B01L 3/502753; B01L 2200/0647; B01L 2200/12

(57) ABSTRACT

The present disclosure provides DNA origami nanoarrays, methods of synthesis thereof, and methods of use thereof.

### PRIORITY STATEMENT

This application claims priority to U.S. Provisional Patent Application No. 63/638,158, filed Apr. 24, 2024 the entire contents of which are incorporated hereby by reference for all purposes.

### FEDERAL FUNDING

This invention was made with government support under 2227650 awarded by the National Science Foundation. The government has certain rights in the invention.

### FIELD

The present disclosure provides compositions and methods related to nanoarrays, including DNA origami nanoarrays.

### BACKGROUND

Single-molecule experiments often face a trade-off between throughput and concentration, as higher concentrations increase the chances of multiple molecules occupying the same diffraction-limited spot, leading to confounding data. Lowering the concentration to overcome this issue reduces the experimental throughput. This trade-off between concentration and throughput poses a significant limitation for conventional single-molecule studies, as a balance between avoiding molecular overlap and maintaining a sufficient number of observable molecules needs to be preserved. Lowering the concentration can lead to excessively long experiment times and reduced statistical power, while higher concentrations risk data corruption due to molecular overlap. Nanosphere lithography (NSL) presents a promising self-assembly-based approach to address this challenge. By leveraging NSL, high-density nanoarrays can be created, enabling the deterministic positioning of molecules at the diffraction limit. Nanosphere lithography (NSL) leverages hexagonal packing of beads, such as polystyrene and silica beads, to produce a mask for the construction of nanoarrays for biophysical assays and diagnostics. To achieve optimal throughput while precisely controlling the positioning of target molecules, it requires close packing, close to the diffraction limit of light. Previous work has shown that DNA origami nanoarrays made with polystyrene (PSS) nanospheres as masks suffer from multiple 100 nm DNA origami structures per spot due to the >100 nm patch size. As such, there is a need for DNA origami nanoarrays that minimize the number of spots with multiple origami structures, along with methods of development thereof.

### SUMMARY

To overcome the throughput versus concentration trade-off in single-molecule experiments, an ideal solution would be to control the positions of molecules-of-interest on a substrate while maximizing throughput. Provided herein are DNA origami nanoarrays that accomplish this goal, namely achieving controlled positions on the substrate while maintaining high experimental throughput. Typically, this balance can be achieved by close-packing the molecules at the diffraction limit of light, which is approximately equal to 2/2NA, where 2 is the wavelength of the excitation light, and NA is the numerical aperture of the objective lens. Provided herein are DNA origami nanoarrays with patch sizes of less than or equal to 100 nm achieved using silica nanospheres, with a Young's modulus of ˜10 GPa, significantly greater compared to a modulus of ˜0.5 GPa for polystyrene beads. In turn, the smaller size of the sticky patch (e.g. adhesion site) reduces the number of spots with multiple DNA origami structures while maintaining a periodicity significantly larger than the diffraction limit of light. Using a self-assembled monolayer of 1 μm silica nanoparticles as masks for NSL, periodic sticky patches (e.g. adhesion sites) (100 nm) at spacing of 1 μm were obtained. Each adhesion site is surrounded by a ring of hexamethyldisilazane (HMDS). The presence of surface-bound water within the interstices of the silica beads facilitated the formation of silane rings. The resulting array had inner ring diameters averaging 100 nm, compatible with circular DNA origami structures. This improves the maximum loading efficiency of single DNA origami onto the nanoarray compared to previous arrays, thus providing a next-generation DNA nanoarray platform for deterministic, high-throughput biophysical applications.

### BRIEF DESCRIPTION OF THE DRAWINGS

FIG. 1 illustrates an exemplary nanoarray described herein.

FIG. 2 is a flowchart for an exemplary method of manufacturing a nanoarray described herein.

FIGS. 3A-3C show a schematic representation of an exemplary fabrication method and function of hexamethyldisilazane (HMDS) ring-patterned surfaces for single-occupancy DNA origami placement. FIG. 3A and FIG. 3B show a stepwise process illustrating the formation of nanopatterned binding sites which starts with close-packing assembly of silica particles on a glass surface (FIG. 3A). HMDS is deposited to cover the background to initiate hydrophobic rings formation around the particle site (FIG. 3B). Selective removal of particles generate a patterned template followed by functionalization of exposed sites for DNA origami attachment. Steric confinement imposed by the HMDS rings limits lateral diffusion of DNA origami and ensures single origami occupancy by suppressing multiple binding events. FIG. 3C shows additional details regarding the processes involved in formation of HMDS rings. Water trapped in the interstitial regions at particle-surface contact sites reacts with HMDS, initiating vertical polymerization and forming a capillary barrier that facilitates the development of a ring-shaped HMDS structure.

FIGS. 4A-4D shows modulation of binding site size through particle stiffness and HMDS ring formation for single-DNA origami patterning. FIG. 4A is a schematic illustrating the Hertzian contact model of spherical indentation for polystyrene and silica particles. Softer polystyrene particles produce larger contact areas, resulting in larger binding site sizes, whereas stiffer silica particles yield smaller contact areas under identical force (F). FIG. 4B is a graph showing binding site size as a function of nanosphere diameter. Data from this study (blue) using rigid silica particles show a significant reduction in binding site size compared to prior studies using polystyrene (gray), highlighting the benefit of material selection. FIG. 4C shows a quantitative comparison of binding site diameters for 1 μm polystyrene beads, amino-modified silica (Silica-NH₂), and HMDS ring-confined silica. FIG. 4D shows atomic force microscopy (AFM) images of patterned surfaces revealing differences in site morphology. Scale bars=1 μm.

### DETAILED DESCRIPTION

The present disclosure provides DNA origami nanoarrays, methods of synthesis thereof, and methods of use thereof. According to the Hertzian contact model, the area on a substrate that is covered by the nanosphere in contact (i.e. the size of the binding site produced in NSL) is influenced by the stiffness of the nanosphere material. PSS nanoparticles, having a lower Young's modulus, experience greater deformation upon contact with the glass surface, resulting in larger binding site sizes. In contrast, materials with higher Young's moduli, such as silica nanoparticles, leave a smaller footprint on the glass substrate. By using silica nanospheres, which have a higher Young's modulus compared to PSS, it is possible to create binding sites smaller than 100 nm with a periodicity larger than the diffraction limit of light, maximizing throughput. Silica nanoparticles are rich in hydroxyl functional groups on their surface and retain moisture despite heating the glass surface. This presents a unique opportunity to create rings around the binding sites due to vertical polymerization of HMDS facilitated by ice-like formation of water traps in the interstices of silica nanoparticles in a close-packed monolayer. Furthermore, the periodicity can be controlled as the function of nanoparticle diameter, allowing for the creation of nanoarrays with user-defined spot separations at/above the diffraction limit of light. This enables the development of low-cost devices that do not require sophisticated microscopes for readout. To reduce the occurrence of multiple origami structures occupying a single binding site, a hydrophobic barrier can be created around each site. This barrier prevents additional origami from entering the binding site and promoting single-origami occupancy. This approach enhances the maximum single-origami loading efficiency, enabling the fabrication of high-density nanoarrays. Consequently, these nanoarrays facilitate high-throughput, deterministic single-molecule experiments by providing a platform that minimizes the occurrence of multiple origami per site while maximizing the number of sites available for individual origami binding.

Section headings as used in this section and the entire disclosure herein are merely for organizational purposes and are not intended to be limiting.

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “about” means a range of plus or minus 10% of that value, e.g., “about 5” means 4.5 to 5.5, “about 100” means 90 to 100, etc., unless the context of the disclosure indicates otherwise, or is inconsistent with such an interpretation. For example, in a list of numerical values such as “about 49, about 50, about 55”, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

The term “DNA origami” as used herein refers to a nanoscale structure of folded DNA that creates two-dimensional and three-dimensional shapes. In DNA origami, a long strands of DNA referred to as a “scaffold” is mixed with an excess number of shorter “staple strands” to drive folding into a complex nanoscale structure.

### 2. Nanoarrays and Methods of Manufacturing the Same

In some aspects, provided herein are nanoarrays. In some embodiments, provided herein are DNA origami nanoarrays. Specifically, the disclosure uses nanosphere lithography (NSL) using silica beads to create high-density, periodic nanoarrays on glass surfaces. By employing silica beads with a higher Young's modulus compared to polystyrene beads, the size of the adhesion site (e.g. sticky patch) can be reduced to less than 100 nm, minimizing the occurrence of multiple DNA origami structures per spot. The resulting nanoarray consists of adhesion sites surrounded by hexamethyldisilazane (HMDS) rings, with inner ring diameters compatible with circular DNA origami structures. This cleanroom-free fabrication method significantly reduces the cost per chip while enabling precise positioning of target molecules at high throughput.

The nanoarrays herein and methods of producing the same may revolutionize biophysical assays and diagnostics by providing a cost-effective, high-throughput platform for deterministic DNA nanoarrays. By improving the maximum loading efficiency of single DNA origami onto the nanoarray, this technology can facilitate advanced applications in fields such as biosensing, drug discovery, and molecular electronics.

The nanoarrays herein comprise several unique features that convey significant advantages. One such unique feature is the use of silica beads for nanosphere lithography (NSL). The nanoarrays herein comprise silica beads, which have a higher Young's modulus (˜10 GPa) compared to polystyrene beads (˜0.5 GPa). By using silica beads of the same diameter as polystyrene beads, smaller adhesion site sizes are achieved. Additionally, consistent patterning is obtained by maintaining the periodicity of the nanoarray at intervals higher than the diffraction limit of light. For example, if the nanoarray has a periodicity of 1 μm (1000 nm), it is well above the diffraction limit of visible light. This higher periodicity allows for the creation of distinct, well-separated features that can be easily resolved using standard optical imaging methods, facilitating the application of the DNA origami nanoarrays to a wide audience.

Another unique feature of the nanoarrays herein is the formation of HMDS rings. The methods herein leverage the presence of surface-bound water within the interstices of the silica beads to facilitate the formation of hexamethyldisilazane (HMDS) rings surrounding the adhesion sites. The resulting nanoarray has inner ring diameters averaging 100±20 nm (for 1 μm pitch), which is compatible with circular DNA origami structures. This unique feature distinguishes the DNA origami nanoarrays herein from existing technologies and contributes to the creation of well-defined, periodic nanoarrays. Specifically, the creation of hydrophobic rings around the patch minimizes the occurrence of multiple DNA origami structures per spot, enhancing the precision and efficiency of the nanoarray.

The nanoarrays herein achieve improved maximum loading efficiency compared to other arrays. This novel aspect enhances the performance and utility of the invention for high-throughput biophysical applications.

Another advantage of the nanoarrays herein is that they are produced by a cleanroom-free fabrication method, which significantly reduces the cost per chip compared to traditional top-down fabrication methods. This novel aspect makes the invention more accessible and cost-effective for researchers and industry professionals.

The nanoarrays herein also achieve precise positioning of each spot on the array. Previous arrays show a single occupancy rate of 74% per site. In contrast, the current invention improves upon this occupancy rate by introducing a hydrophobic barrier around each adhesion site and a method by which single DNA origami can be placed per spot. Without a hydrophobic barrier, the attachment of DNA origami structures to the adhesion sites may be more susceptible to variations in environmental conditions, such as humidity or temperature. These variations can lead to inconsistencies in the single occupancy rate and the occurrence of multiple occupancy across different experiments or samples. By preventing multiple DNA origami structures from adhering to the same spot using the fabrication methods herein, the single occupancy rate is higher, leading to more reliable and accurate data in single-molecule experiments and diagnostic assays for healthcare. Additionally, this high-throughput production capability is advantageous over existing technologies such as electron-beam lithography, which may be more time-consuming or limited in terms of scalability.

Applications of the nanoarrays (e.g. DNA origami nanoarrays) provided herein include healthcare applications (e.g. diagnostic tools) and data storage/biocomputing. The precise positioning of target molecules and improved loading efficiency offered by this technology can lead to the development of more sensitive and accurate diagnostic tools. For example, DNA origami nanoarray can be used as a low-cost digital diagnostic technology for many diseases without complex microfluidic devices, bulky microscopes, or PCR machines. By ensuring that each site on the nanoarray contains only a single target molecule, the signal-to-noise ratio of the assay can be significantly improved. This increased sensitivity allows for the detection of diseases at earlier stages, when biomarker concentrations are typically lower. Such a platform may rival the sensitivity of droplet digital PCR (1 molecule in 20 μL of sample). Further, the DNA origami nanoarrays herein can be used to develop diagnostic tools capable of multiplexed detection of biomarkers or genetic variations while maintaining specificity and can reach extremely small detection levels (sub-femtomolar) two-three orders of magnitude more sensitive than traditional antibody assays. The high-throughput, cost-effective production of DNA origami nanoarrays herein can accelerate biophysical research by providing researchers with a powerful tool for investigating molecular interactions, protein folding, and other complex biological processes. This cleanroom-free, bottom-up approach offers several advantages that can revolutionize nanoscale fabrication and have far-reaching economic implications. By eliminating the need for expensive cleanroom facilities, this approach significantly reduces the cost and time associated with nanoscale fabrication.

The nanoarrays produced using the methods herein are compatible with a wide range of biophysical applications, including biosensing, drug discovery, and molecular electronics. The ability to customize the nanoarrays for specific applications makes this technology highly versatile and adaptable.

Photonic circuits have revolutionized information storage, enabling fast access times and increased bandwidth. Despite significant progress in bit-level optical memories and integrated optical memory technologies, the inherent diffraction limit remains a fundamental obstacle to further reducing the size of memory elements and increasing storage capacity. Metamaterials, composed of designed periodic structures, manipulate light at a deep subwavelength level. Digital or programmable metamaterials design the metamaterial structure pattern like binary codes, but critical fabrication challenges exist in creating these pre-designed programmable metamaterials, especially at the nanoscale coding size and in a scalable fashion. The DNA origami nanoarrays herein with precise positioning of target molecules and improved loading efficiency can be used in a DNA Meta-RAM system that addresses the challenges in programmable metamaterial fabrication and enables digital information encoding, analysis, and decoding at the nanoscale and can revolutionize electronic systems and pave the way for next-generation, high-performance information processing devices.

In some aspects, provided herein are nanoarrays. In some embodiments, provided herein is a nanoarray comprising a substrate comprising a plurality of adhesion sites. As used herein, the term “adhesion site” refers to a region on the nanoarray suitable for attachment of a moiety to the adhesion site. For example, the moiety may bind to, adhere to, or otherwise be attached to the adhesion site or retained on the surface of the adhesion site. The term “adhesion site” is used interchangeably herein with “sticky patch site” or “sticky patch”. In some embodiments, each adhesion site is substantially circular in shape and has an average diameter of less than 200 nm. For example, in some embodiments each adhesion site has an average diameter of less than 200 nm, less than 190 nm, less than 180 nm, less than 170 nm, less than 160 nm, less than 150 nm, less than 140 nm, less than 130 nm, less than 120 nm, less than 110 nm, less than 100 nm, or less than 90 nm. In some embodiments each adhesion site has an average diameter of about 80 nm to about 200 nm. In some embodiments, each adhesion site has an average diameter of about 80 nm to about 200 nm, about 80 nm to about 180 nm, about 80 nm to about 160 nm, about 80 nm to about 140 nm, about 80 nm to about 120 nm, about 90 to about 110 nm, or about 100 nm.

In some embodiments, the average distance between centers of the plurality of adhesion sites is about 800 μm to about 1200 μm. In some embodiments, a periodicity of the nanoarray is equal to or above the diffraction limit of light. In some embodiments, the average distance between centers of the plurality of adhesion sites is about 800 μm to about 1200 μm, about 820 μm to about 1180 μm, about 840 μm to about 1160 μm, about 860 μm to about 1140 μm, about 880 μm to about 1120 μm, about 900 μm to about 1100 μm, about 920 μm to about 1080 μm, about 940 μm to about 1060 μm, about 960 μm to about 1040 μm, about 980 μm to about 1020 μm, or about 1000 μm.

In some embodiments, the substrate comprises glass.

In some embodiments, each adhesion site further comprises a hydrophobic barrier that forms a perimeter substantially surrounding the adhesion site. The term “substantially surrounding” indicates that the hydrophobic barrier forms a perimeter around the adhesion site. The hydrophobic barrier does not completely encapsulate the adhesion site.

In some embodiments, the hydrophobic barrier comprises hexamethyldisilazine (HMDS). In some embodiments, the hydrophobic barrier comprises polymerized HDMS.

In some embodiments, the nanoarray further comprises a plurality of DNA origami structures bound to the adhesion sites. A nanoarray comprising DNA origami structures bound to the adhesion sites is referred to herein as a “DNA origami nanoarray”. The DNA origami nanoarrays herein are advantageous in that a high percentage of the adhesion sites are bound to a single DNA origami structure, in contrast to other methods which are hindered by multiple structures binding to a single binding site. In some embodiments, at least 80% of the adhesion sites are bound to a single DNA origami structure. In some embodiments, at least 90% of the adhesion sites are bound to a single DNA origami structure. For example, in some embodiments at least 80%, at least 81%, at least 82%, at least 83%, at least 84%, at least 85%, 86%, at least 87%, at least 88%, at least 89%, at least 90%, at least 91%, at least 92%, at least 93%, at least 94%, or at least 95% adhesion sites are bound to a single DNA origami structure.

In some aspects, provided herein is a method comprising contacting a sample with a nanoarray (e.g. DNA origami nanoarray) described herein. The sample may comprise a target and the DNA origami nanoarray facilitates ultra-sensitive detection of the target, for example at sub-femtomolar concentrations of the target. In some embodiments, the strands involved in DNA origami synthesis (e.g. the scaffold strand) can be designed for detection of any desirable target, including biomarkers for disease states.

In some aspects, provided herein are methods of manufacturing a nanoarray. In some embodiments, the method comprises adhering silica nanoparticles to the surface of a substrate, generating a hydrophobic barrier around each of the silica nanoparticles, and removing the silica nanoparticles from the surface of the substrate while retaining the hydrophobic barrier on the surface of the substrate, thereby generating a nanoarray comprising a plurality of adhesion sites on the surface of the substrate, each adhesion site comprising a hydrophobic barrier that defines an outer perimeter around the adhesion site.

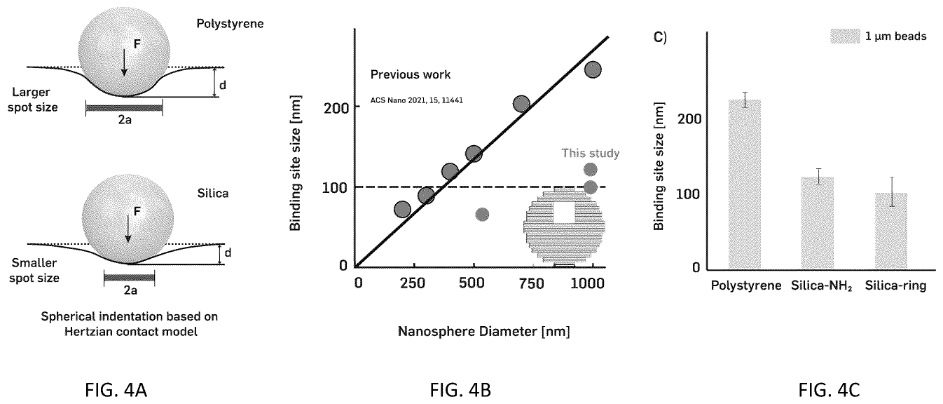

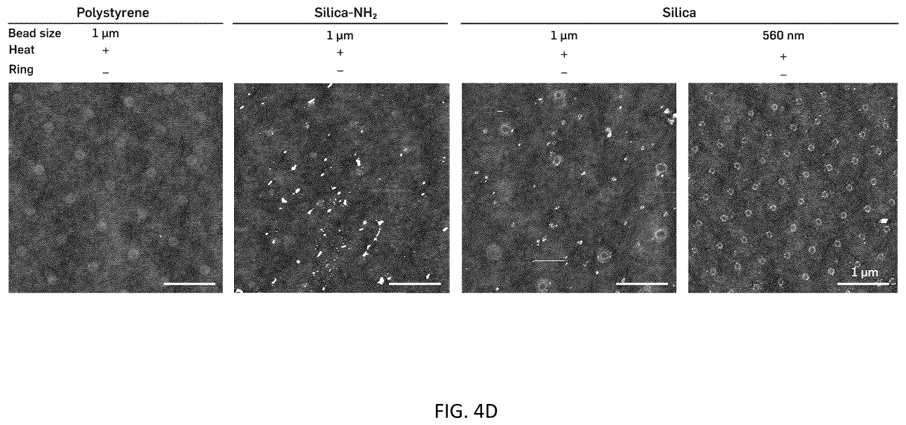

In some embodiments, the silica nanoparticles are substantially spherical in shape and each have an average diameter of less than 1000 nm. In some embodiments, the silica nanoparticles are substantially spherical in shape and have an average diameter of less than 1000 nm, less than 900 nm, less than 800 nm, less than 700 nm, less than 600 nm, less than 500 nm, less than 400 nm, less than 300 nm, or less than 200 nm. In some embodiments, the average diameter is 200 nm to 800 nm. For example, in some embodiments the average diameter is 200 nm to 800 nm, 250 nm to 750 nm, 300 nm to 700 nm, 350 nm to 650 nm, or 400 nm to 600 nm. In some embodiments, the average diameter is 400 nm to 600 nm, 420 nm to 600 nm, 440 nm to 600 nm, 460 nm to 600 nm, 480 nm to 600 nm, 500 nm to 600 nm, 520 nm to 600 nm, 540 nm to 580 nm, or about 560 nm. As shown in FIG. 4, the size and hardness of the silica nanoparticles can be optimized to produce a nanoarray having the desired size and spacing of the adhesion sites (e.g. sticky patch sites). The size and hardness of the silica particles used herein produces a nanoarray with significant improvements over previous nanoarrays developed using other particles, such as polystyrene particles.

In some embodiments, the silica nanoparticles have a Young's modulus of at least 1 GPa. For example, in some embodiments the silica nanoparticles have a Young's modulus of at least 1 GPa, at least 2 GPa, at least 3 GPa, at least 4 GPa, at least 5 GPa, at least 6 GPa, at least 7 GPa, at least 8 GPa, at least 9 GPa, or about 10 GPa.

In some embodiments, the hydrophobic barrier comprises hexamethyldisilazine (HMDS). In some embodiments, generating the hydrophobic barrier comprises contacting the substrate with HDMS, such that HDMS interacts with water molecules present between the silica nanoparticles and polymerizes, thereby forming a perimeter around the silica nanoparticles. In some embodiments, the hydrophobic barrier is in contact with the glass substrate, such that during removal of the silica nanoparticles the hydrophobic barrier remains in place on the substrate.

In some embodiments, the substrate comprises glass. In some embodiments, the glass and/or the silica nanoparticles are treated/functionalized to facilitate adhesion of the silica nanoparticles to the glass surface. For example, the silica particles may carry a negative charge and the glass substrate can be positively charged such that the silica particles adhere to the glass substrate by electrostatics. Alternatively, silica nanoparticles can be functionalized with a suitable reactive group such that the silica nanoparticles interact with and form bonds (e.g. covalent bonds) with groups present on the glass surface. For example, silica nanoparticles can be functionalized with silane coupling agents that bond to silanes present on the glass surface. Alternatively, the glass surface may be treated with an adhesive agent such that the silica nanoparticles adhere/stick to the glass surface after placement onto the glass (e.g. after drop-casting). Still alternatively, the glass surface may be etched (e.g. with plasma) which removes a thin layer from the surface and exposes hydroxyl functional groups beneath. These hydroxyl functional groups bind to the silica particles during formation of the nanoarray, and after removal of the silica nanoparticles these functional groups are available to interact with and bind origami DNA, e.g. by formation of a salt bridge between divalent ions (e.g. magnesium ions) and the hydroxyl functional groups in the glass.

In some embodiments, the method comprises removing the silica nanoparticles from the substrate while retaining the hydrophobic barrier, thereby forming the plurality of adhesion sites. The silica nanoparticles may be removed by any suitable method that achieves removal of the silica nanoparticles and retention of the hydrophobic barrier. In some embodiments, the silica nanoparticles are removed by water sonication.

In some embodiments, the plurality of adhesion sites formed after removal of the silica nanoparticles are substantially circular in shape and have an average diameter of less than 200 nm. Generally speaking, the size of the adhesion sites depends on the size of silica nanoparticles used in creating the nanoarray. In some embodiments, each adhesion site has an average diameter of less than 200 nm, less than 190 nm, less than 180 nm, less than 170 nm, less than 160 nm, less than 150 nm, less than 140 nm, less than 130 nm, less than 120 nm, less than 110 nm, less than 100 nm, or less than 90 nm. In some embodiments each adhesion site has an average diameter of about 80 nm to about 200 nm. In some embodiments, each adhesion site has an average diameter of about 80 nm to about 200 nm, about 80 nm to about 180 nm, about 80 nm to about 160 nm, about 80 nm to about 140 nm, about 80 nm to about 120 nm, about 90 to about 110 nm, or about 100 nm.

In some embodiments, the average distance between centers of the plurality of adhesion sites is 800 μm to 1200 μm, such that a periodicity of the nanoarray is equal to or above the diffraction limit of light. In some embodiments, the average distance between centers of the plurality of adhesion sites is about 800 μm to about 1200 μm, about 820 μm to about 1180 μm, about 840 μm to about 1160 μm, about 860 μm to about 1140 μm, about 880 μm to about 1120 μm, about 900 μm to about 1100 μm, about 920 μm to about 1080 μm, about 940 μm to about 1060 μm, about 960 μm to about 1040 μm, about 980 μm to about 1020 μm, or about 1000 μm.

In some embodiments, the method further comprises contacting the nanoarray with a plurality of DNA origami structures that bind to the plurality of adhesion sites, thereby forming a DNA origami nanoarray. In some embodiments, the substrate was treated with an adhesive reagent to facilitate attachment of the silica nanoparticles to the substrate, and the method for removing the silica nanoparticles retains the adhesive property of the substrate after removal of the silica nanoparticles such that the DNA origami structures bind to the adhesive agent that remains in the adhesion site. For example, in some embodiments the glass is treated with an adhesive agent comprising activated hydroxyl functional groups, or the glass is etched (e.g. by plasma) to expose hydroxyl functional groups which originally bind to the silica particles, which are then removed from the array leaving exposed hydroxyl functional groups on the glass. The DNA origami binds to the activated hydroxyl functional groups, for example by formation of a salt bridge between divalent ions (e.g. magnesium ions) and the activated hydroxyl functional groups. The divalent ions that facilitate formation of this salt bridge can be added with the DNA origami, e.g. in a buffer used to facilitate addition of the DNA origami to the nanoarray.

In some embodiments, at least 80% of the adhesion sites bind to a single DNA origami structure. In some embodiments, at least 90% of the adhesion sites bind to a single DNA origami structure. For example, in some embodiments at least 80%, at least 81%, at least 82%, at least 83%, at least 84%, at least 85%, 86%, at least 87%, at least 88%, at least 89%, at least 90%, at least 91%, at least 92%, at least 93%, at least 94%, or at least 95% adhesion sites bind to a single DNA origami structure.

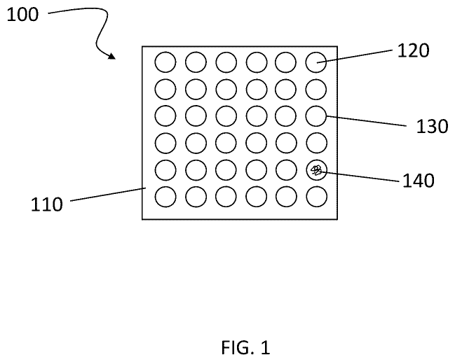

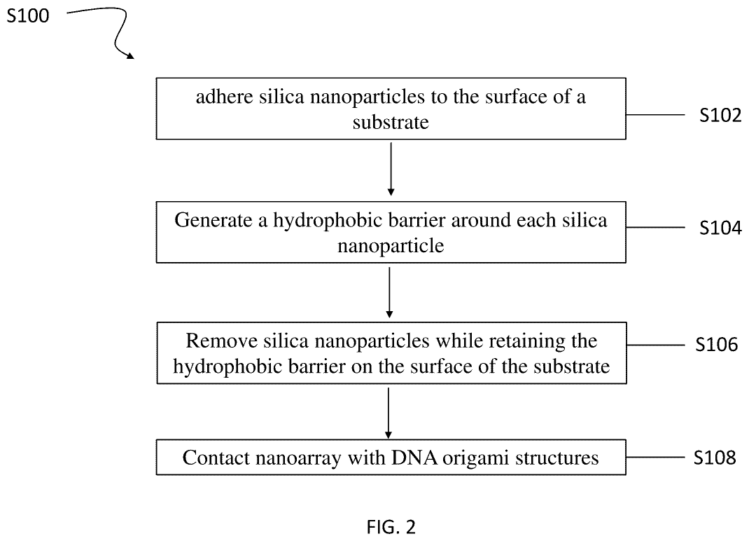

Further details are provided below with respect to FIGS. 1 and 2.

FIG. 1 illustrates an exemplary nanoarray according to various embodiments described herein. The relative sizes/dimensions of the features shown in FIG. 1 are not drawn to scale and are not intended to represent the exact size, shape, number, and/or arrangement of the features. The nanoarray (100) includes a substrate (110) comprising a plurality of adhesion sites (120). Each adhesion site (120) is substantially circular in shape and has an average diameter of less than 200 nm. The average distance between centers of the plurality of adhesion sites (120) is 800 μm to 1200 μm. In some embodiments, as illustrated in FIG. 1, each adhesion site (120) further comprises a hydrophobic barrier (130) that forms a perimeter substantially surrounding the adhesion site. In some embodiments, the hydrophobic barrier comprises HMDS. In some embodiments, as illustrated in FIG. 1, the nanoarray comprises a plurality of DNA origami structures (140) bound to the adhesion sites. The nanoarrays herein achieve a high percentage of adhesion sites (120) that are bound to a single DNA origami structure, as opposed to being bound to multiple DNA origami structures. In some embodiments, at least 80% of the adhesion sites (120) are bound to a single DNA origami structure (140).

FIG. 2 illustrates a flowchart of an exemplary method (S100) of producing a nanoarray described herein. The method S100 includes at step S102 adhering silica nanoparticles to the surface of a substrate. In some embodiments, the silica nanoparticles have an average diameter of less than 200 nm. In some embodiments, the substrate comprises glass. The glass and/or silica nanoparticles may be treated or functionalized to facilitate attachment of the silica nanoparticles to the glass surface. The method includes at step S104 generating a hydrophobic barrier around each silica nanoparticle. In some embodiments, the hydrophobic barrier comprises HMDS. In some embodiments, generating the hydrophobic barrier comprises contacting the substrate with HMDS, which interacts with water particles present in the interstices of the silica nanoparticles and polymerizes. The method includes at step S106 removing the silica nanoparticles from the surface of the substrate while retaining the hydrophobic barrier on the surface of the substrate. This may be accomplished, for example, by water sonication to remove the silica nanoparticles. Removal of the silica nanoparticles results in the manufacture of a nanoarray as described herein comprising a substrate comprising a plurality of adhesion sites, each adhesion site comprising a hydrophobic barrier that forms a perimeter substantially surrounding the adhesion site. In some embodiments, the method includes at step S106 contacting the nanoarray with a plurality of DNA origami structures, which bind/adhere to the adhesion sites.

### 3. EXAMPLES

It will be readily apparent to those skilled in the art that other suitable modifications and adaptations of the methods of the present disclosure described herein are readily applicable and appreciable, and may be made using suitable equivalents without departing from the scope of the present disclosure or the aspects and embodiments disclosed herein. Having now described the present disclosure in detail, the same will be more clearly understood by reference to the following examples, which are merely intended only to illustrate some aspects and embodiments of the disclosure, and should not be viewed as limiting to the scope of the disclosure. The disclosures of all journal references, U.S. patents, and publications referred to herein are hereby incorporated by reference in their entireties.

The present disclosure has multiple aspects, illustrated by the following non-limiting examples.

### Example 1

DNA origami was annealed and purified as follows:

Staple strands were purchased from Integrated DNA Technologies, 640 nM each in water and the scaffold strand (single-stranded p8064, 400 nM from Bayou Labs, and used without further purification. Scaffold and staple strands were mixed together in 1:5 ratio to target concentrations in 40 mM Tris, 20 mM Acetate, and 1 mM Ethylenediaminetetraacetic acid (EDTA) with a typical pH around 8.6, and 12.5 mM magnesium chloride (MgCl₂) (1× TAE/Mg²⁺). The staple mix (100 μL) were heated to 90° C. for 5 min, and annealed from 90° C. to 25° C. at 0.1° C./min in a PCR machine. Annealed origami were purified using 100 kD molecular weight cut-off filters (MWCO) spin filters (Amicon Ultra-0.5 Centrifugal Filter Units with Ultracel-100 membranes, Millipore, UFC510024) to remove excess staples as they will inhibit DNA origami placement.

Using the protocol below, recovery was generally 40-50%, and staples were no longer visible by agarose gel electrophoresis:
1. Wet the membrane of the spin filter by adding 500 μL 1×TAE/Mg²⁺.
2. Centrifuge at 6000 ref for 5 min at room temperature (RT), until the volume in the filter is ˜80 μL.
3. Discard the filtrate.
4. Add 100 μL of unpurified origami and 300 μL 1×TAE/Mg²⁺. Spin at 6000 ref for 5 min at RT.
5. Discard the filtrate.
6. Add 420 μL 1×TAE/Mg²⁺ and spin at 6000 ref for 5 min at RT.
7. Repeat step (4) two more times.
8. Invert the filter into a clean tube and spin at 6000 ref for 5 min at RT to collect purified origami (˜80 μL).

A nanoarray with silica nanoparticles was then prepared. The following materials were used. However, it is understood that suitable variations of the equipment below may be used, including equipment that achieves the same or a similar purpose and equipment sold by other vendors.

### Materials:

10×10 mm² coverslips (Ted Pella, 260375-15).

Plasma cleaner (Harrick Basic Plasma Cleaner PDC-32G/PDC-32G-2)

Hotplate and stirrer (Denville)

Desiccator (Hach, Product no. 223830)

Branson ultrasonic bath, AFM (Bruker FastScan).

Appropriately sized Silica microspheres (NanoXact, 1 μm, Nanocomposix)

Passivation agent: HMDS (440191-100 mL, Sigma).

The Protocol for binding site creation was as follows. Coverslips were washed with isopropanol (IPA) for 2 minutes and blow-dried with nitrogen. A ten minute air plasma cleaning (Harrick plasma cleaner at ˜18 W (“High” setting)) was carried out on the glass. Exposure of the glass to plasma etches a thin layer (e.g. nanometer thick layer) of the glass, removing any organic contaminants which would limit DNA origami adhesion, and revealing hydroxyl groups beneath. The chip surface is now considered “activated”.

1000 μL of 1 μm silica nanoparticles (concentration: 10 μg/ml) were pipetted into an Eppendorf tube and spun at 8,000-10,000 rpm for 5 min. A faster and/or longer spinning creates smaller nanosphere sizes compared to a shorter and/or slower spinning cycle. Supernatant was removed and 1000 μL of ultrapure water was added to re-suspend pellet. After resuspension, tubes were spun at 8,000-10,000 rpm for 5 minutes. Supernatant was removed and pellet was re-suspended pellet in 25% ethanol and 75% water (total volume: 200 μL).

Silica nanospheres were drop-cast onto the activated chip surface by depositing 5-10 μL of the resuspended pellet and left to dry at a ˜45° angle at room temperature (resting against a glass stirrer or similar object). Once dried, a diffraction pattern (crystalline structure) was observed, confirming the existence of a close-packed monolayer/multilayer of nanospheres.

The chip was heated at 60° C. for 5 min to remove excessive moisture. This does not evaporate the water trapped in the interstices. A 2 minute “descum” plasma in air was carried out (at ˜18 W in Harrickplasma cleaner) on the monolayer. Chips were moved to a dessicator, 8-10 drops of HMDS were added (in a glass cuvette), and chips were deposited under a vacuum seal for 1 hour.

Silica nanospheres were lifted off with water sonication in a Branson ultrasonic bath for 30-60 seconds. The chip was blow dried with a nitrogen gun to create origami binding sites. The chip was baked at 120° C. for 5 min to stabilize the HMDS on the surface.

DNA origami were then placed on the chips as follows. Chips were incubated with ˜100-200 pM origami (nominal concentration for 1 μm pitch, concentration inversely proportional to nanosphere size) in ˜ 40 mM Mg, Tris-HCl (40 mM Tris) buffer (pH-8.3) for 60 minutes. Chips were washed in 40 mM Mg, Tris-HCl (40 mM Tris) buffer (pH-8.3) for 5 minutes either manually or automatically using a peristaltic pump or shaker in a petri dish. Chips were transferred to 40 mM Mg, Tris-HCl (40 mM Tris) buffer (pH-8.3)+0.07% Tween 20 and washed for 5 minutes. Chips were transferred to ˜35 mM Mg, 10 mM Tris (pH-8.9) to hydrolyze the HMDS and lift off origami non-specifically bound to the background, and washed for 5 min.

For AFM characterization, chips were transferred to an ethanol drying series as follows: 10 seconds in 50% ethanol, 20 seconds in 75% ethanol, and 2 minutes in 85% ethanol. Chips were then air-dried, followed by AFM/fluorescence verification of patterning.

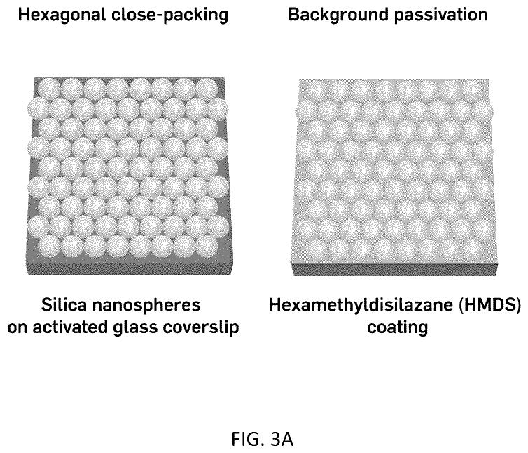

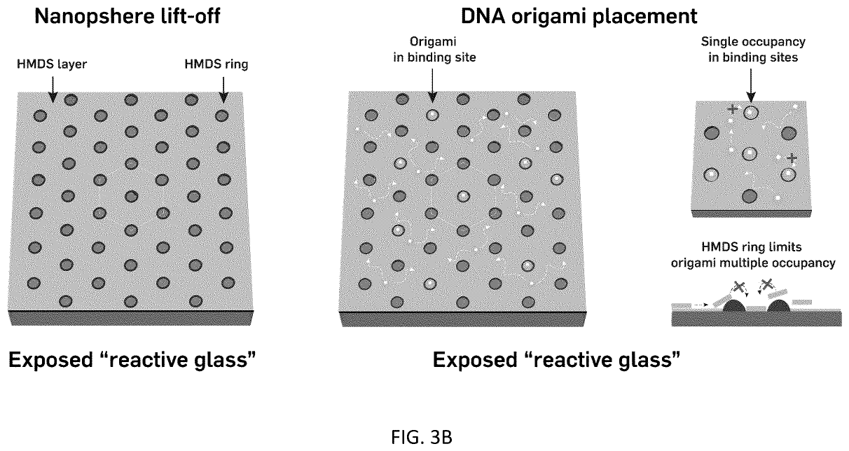

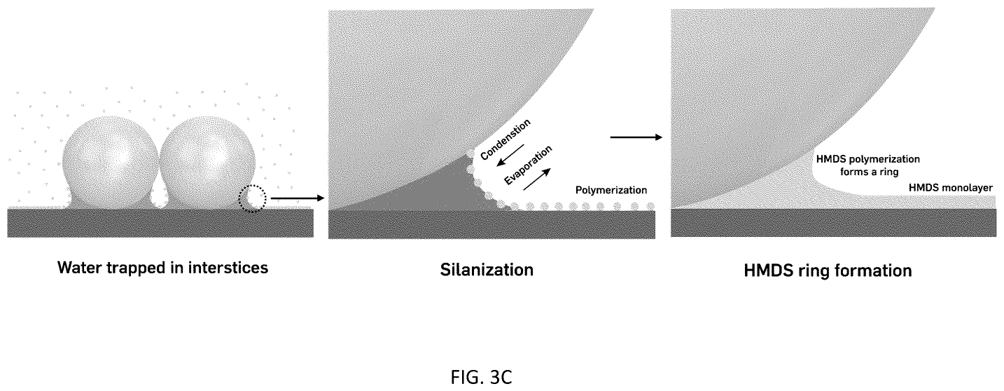

The protocol for creating the nanoarray is represented visually in the schematic of FIG. 3. Results using the nanoarray are shown in FIG. 4. FIG. 4 shows effective modulation of binding site size through particle stiffness and HMDS ring formation for single-DNA origami patterning. As shown in FIG. 4B, data from this study (blue) using rigid silica particles show a significant reduction in binding site size compared to prior studies using polystyrene (gray), highlighting the benefit of material selection. A quantitative comparison of binding site diameters for 1 μm polystyrene beads, amino-modified silica (Silica-NH₂), and HMDS ring-confined silica is shown in FIG. 4C. Ring confinement further reduces spot size by suppressing lateral diffusion during functionalization. FIG. 4D shows atomic force microscopy (AFM) images of patterned surfaces revealing differences in site morphology. Polystyrene beads results in large, diffuse binding regions. Amino-modified silica yields irregular patterns. In contrast, unmodified silica particles and those patterned with HMDS rings show well-defined, compact binding sites, with the smallest and most uniform features observed using 560 nm silica particles and HMDS confinement.

What is claimed is:

1. A nanoarray comprising:
a) A substrate comprising a plurality of adhesion sites, wherein each adhesion site is substantially circular in shape and has an average diameter of less than 200 nm,
b) wherein an average distance between centers of the plurality of adhesion sites is 800 μm to 1200 μm, such that a periodicity of the nanoarray is equal to or above the diffraction limit of light.

2. The nanoarray of claim 1, wherein the substrate comprises glass.

3. The nanoarray of claim 1, wherein each adhesion site has an average diameter of less than 150 nm.

4. The nanoarray of claim 1, wherein each adhesion site has an average diameter of about 80 nm to 120 nm.

5. The nanoarray of claim 1, wherein each adhesion site has an average diameter of about 100 nm.

6. The nanoarray of claim 1, wherein each adhesion site further comprises a hydrophobic barrier that forms a perimeter substantially surrounding the adhesion site.

7. The nanoarray of claim 6, wherein the hydrophobic barrier comprises hexamethyldisilazine (HMDS).

8. The nanoarray of claim 1, further comprising a plurality of DNA origami structures bound to the adhesion sites, wherein at least 80% of the adhesion sites are bound to a single DNA origami structure.

9. The nanoarray of claim 8, wherein at least 90% of the adhesion sites are bound to a single DNA origami structure.

10. A method comprising contacting a sample with the nanoarray of claim 8.

11. A method of manufacturing a nanoarray, comprising:
a) adhering silica nanoparticles to the surface of a substrate,
b) generating a hydrophobic barrier around each of the silica nanoparticles;
c) removing the silica nanoparticles from the surface of the substrate while retaining the hydrophobic barrier on the surface of the substrate, thereby generating a nanoarray comprising a plurality of adhesion sites on the surface of the substrate, wherein each adhesion site comprises a hydrophobic barrier that defines an outer perimeter around the adhesion site.

12. The method of claim 11, wherein the silica nanoparticles are substantially spherical in shape and each have an average diameter of less than 1000 nm.

13. The method of claim 12, wherein the average diameter is 200 nm to 800 nm.

14. The method of claim 11, wherein the silica nanoparticles have a Young's modulus of about 10 GPa.

15. The method of claim 11, wherein the hydrophobic barrier comprises hexamethyldisilazine (HMDS).

16. The method of claim 15, wherein generating the hydrophobic barrier comprises contacting the substrate with HDMS, such that HDMS interacts with water molecules present between the silica nanoparticles and polymerizes, thereby forming a perimeter around the silica nanoparticles.

17. The method of claim 11, wherein the substrate comprises glass.

18. The method of claim 11, wherein the plurality of adhesion sites are substantially circular in shape and have an average diameter of less than 200 nm, and wherein an average distance between centers of the plurality of adhesion sites is 800 μm to 1200 μm, such that a periodicity of the nanoarray is equal to or above the diffraction limit of light.

19. The method of claim 11, further comprising contacting the nanoarray with a plurality of DNA origami structures that bind to the plurality of adhesion sites, wherein at least 80% of the adhesion sites bind to a single DNA origami structure.

20. The method of claim 19, wherein at least 90% of the adhesion sites bind to a single DNA origami structure.
